(19) United States
(12) Patent Application Publication
(10) Pub. No.: US 2024/0400272 A1
(43) Pub. Date: Dec. 5, 2024

(54) BOTTLE FOR A CONTAINER FOR PARENTERALLY ADMINISTRABLE PHARMACEUTICAL PRODUCTS

(71) Applicant: BISIO PROGETTI S.P.A., Alessandria (IT)

(72) Inventor: Matteo ARCURI, Alessandria (IT)

(21) Appl. No.: 18/273,809

(22) PCT Filed: Jan. 18, 2022
(86) PCT No.: PCT/IB2022/050393

§ 371 Date: Jul. 24, 2023

(30) Foreign Application Priority Data
Feb. 12, 2021 (IT) 102021000003188

(51) Int. Cl. B65D 51/20; A61J 1/14; B65D 1/02; B65D 51/00

(52) U.S. Cl. CPC B65D 51/20; A61J 1/1406; B65D 1/0246; B65D 51/002

(57) ABSTRACT

A bottle having a neck ending superiorly in an access mouth defined by a radially protruding ridge is provided. The ridge height is about ¼ of the neck height and the maximum width of the ridge substantially corresponds to the ridge height. The bottle is provided with a completely redesigned neck and relative ridge to provide greater space for a closing device, ensuring sufficient fixing grip against tampering, and maintaining reduced dimensions without resizing the inner diameter.

The present invention relates in general to the field of containers for injecting pharmaceutical products, typically sealed by a rubber closure and by a further removable safety cap.

Pharmaceutical containers are known in the field, in the form of glass bottles, sealed by a rubber closure in the form of a disc and by a further safety cap which completely covers such rubber closure and which is removable, at least partially, by tearing.

In the case of containers for parenterally administrable drugs, it is essential that the rubber closure remains firmly pressed into the container neck. In the case of parenterally administrable drugs, in fact, only the upper portion of the cap may be opened, for example by tearing, to allow exposure of the upper part of the rubber closure intended to be pierced by the needle of a syringe, used to withdraw the pharmacological solution contained inside the container.

In the field, containers for parenterally administrable drugs closed by caps made of metal, in particular aluminum, are known. One of the advantages of aluminum lies in the deformability of the material which allows the cap to be easily fixed in position by folding a lower end thereof under the edge of the container neck. Furthermore, a cap entirely made of metal allows very reduced 1 thickness and dimensions to be maintained. However, the metal cap has a number of disadvantages, linked precisely to the material. A thin metal cap may in fact deform undesirably during the filling and cleaning steps of the containers. A further drawback lies in the fact that minute metal particles may detach during the tear-open step and come into contact with the rubber closure, contaminating it.

In the field, containers for parenterally administrable drugs closed by plastic caps are known. Such an example is described in document US 2016/184182 (A1), in which the cap comprises an upper portion which may be opened to expose the pierceable area of the rubber closure, and a fixed lower portion to keep the rubber closure firmly in the sealing position. In this solution, the fixed portion is snap-engaged to the edge of the container neck and extends to cover the entire neck. While this solution reduces the risks of tampering, given that it is difficult to access under the cap to try to tamper with it, it still has some drawbacks. In fact, in the event of accidental blows at the lower edge or tampering attempts, there is in any case the risk that the fixed portion is released from the neck of the container, making the pressure force on the rubber closure disappear and compromising the hermetic closure thereof. Furthermore, this known container does not have sufficient space at the neck to be able to house further fixing elements of the rubber closure.

The object of the present invention is to provide a bottle for a container for parenterally administrable pharmaceutical products which solves the drawbacks of the prior art taking into account the needs of the field.

In particular, the object of the present invention is to provide a bottle with more space at the neck to house more than one fixing element of the rubber closure.

Another object of the invention is to provide a bottle which, together with the relative closing device, maintains reduced spaces and dimensions.

Another object of the invention is to provide a bottle which, together with the relative closing device, maintains reduced spaces and dimensions without resizing the inner diameter of the neck, intended for the withdrawal of the parenterally administrable pharmaceutical solution contained therein.

Another object of the invention is to provide a bottle which meets the above requirements and which may be made of glass.

Such object is achieved by a bottle for a container for parenterally administrable pharmaceutical products according to claim 1, and by a relative container according to claim 8. The dependent claims describe preferred embodiments of the invention.

The features and advantages of the bottle according to the present invention will appear more clearly from the following description, made by way of an indicative and non-limiting example with reference to the accompanying figures, in which:

FIG. 1 shows an example of a bottle for a container for parenterally administrable pharmaceutical products belonging to the prior art;

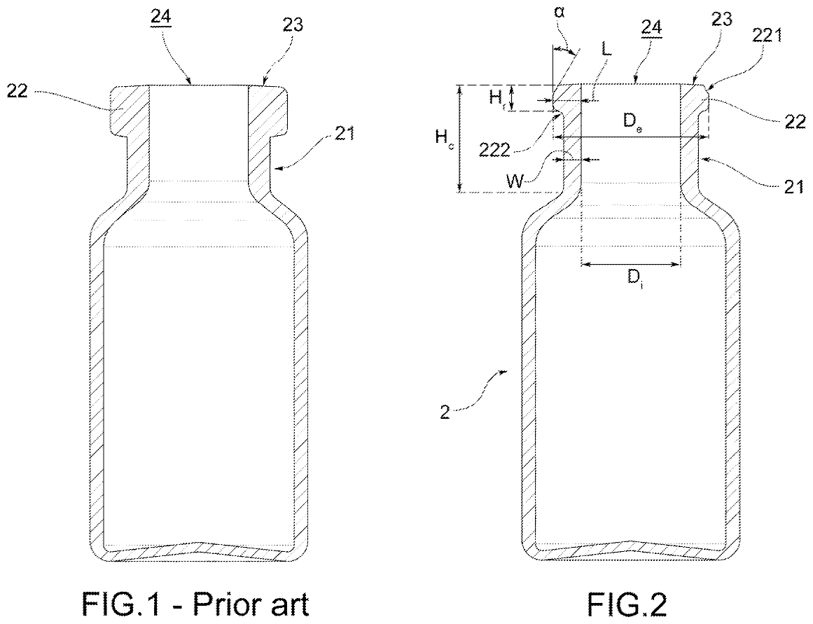

FIG. 2 shows a bottle for a container for parenterally administrable pharmaceutical products according to the present invention;

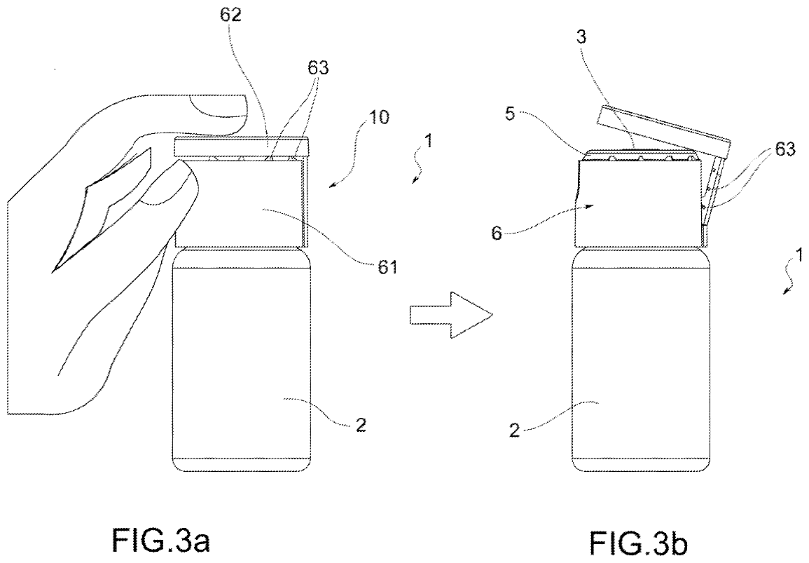

FIGS. 3A and 3B show the steps of opening a container according to the present invention, in which a closing device has been applied to the bottle of FIG. 2, in particular the tear-off removal of an outer cap;

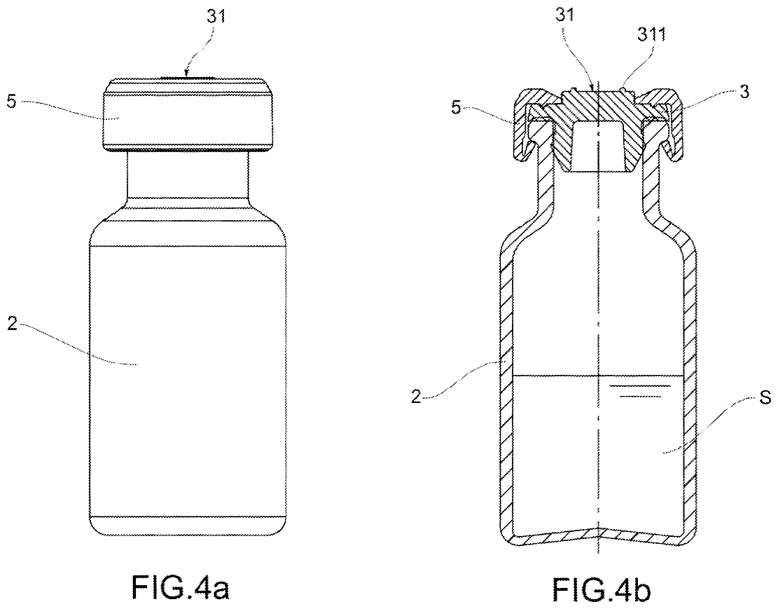

FIGS. 4A and 4B show a front view and a sectional view, respectively, of a container according to the present invention, in which a closing device has been applied to the bottle of FIG. 2, in particular after an outer cap has been completely removed;

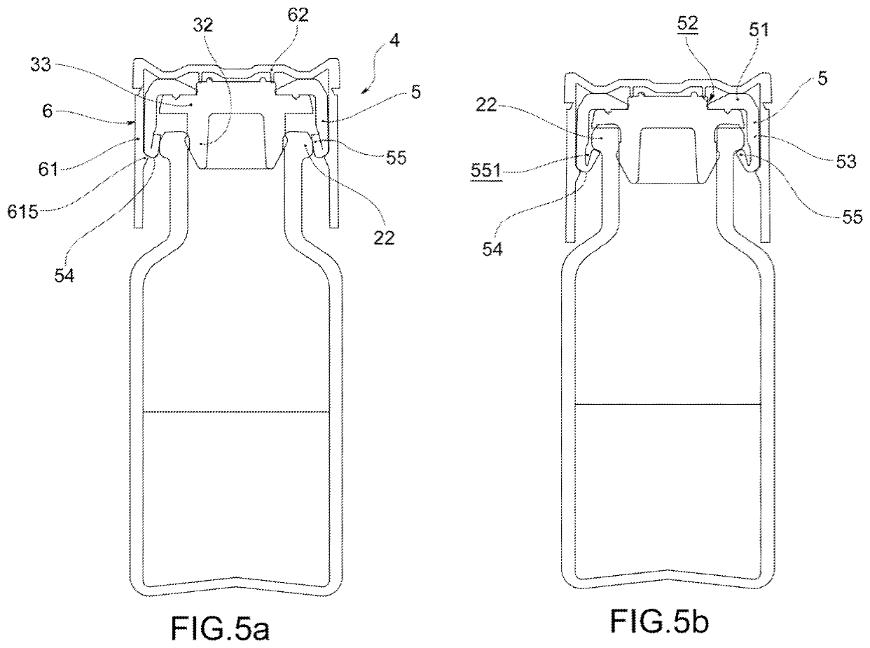

FIGS. 5A and 5B show the assembly steps of the container according to the present invention, in particular the assembly steps of a closing device on the bottle of FIG. 2.

In the accompanying figures, the reference numeral 1 indicates a container for parenterally administrable pharmaceutical products comprising a bottle 2 closed by a closing device 10 made of a sealing element 3, for example made of rubber, and a safety cap 4, for example made of plastic, partially tear-off and adapted to guarantee the authenticity of the container, highlighting any tampering.

The safety cap 4 completely covers the sealing element 3 and may be removed at least partially in order to expose a pierceable portion 31 of such sealing element 3 intended to be pierced by the needle of a syringe in order to be able to withdraw the pharmacological solution S contained in the bottle 2.

The bottle 2, shown in detail in FIG. 2, is intended to contain a parenterally administrable pharmacological solution S and is provided with a neck 21 ending superiorly in an edge 23 which defines the mouth 24 of the bottle itself. The edge 23 is provided with a ridge 22 protruding radially from the neck 21 and having an outer diameter greater than the outer diameter of the neck 21.

In the container 1, the mouth 24 of the bottle 2 is closed by a sealing element 3.

The sealing element 3 is a rubber cap which seals in a sterile manner the contents of the bottle 2 from the environment, and which may be pierced by a hypodermic needle, not shown in the drawings, to remove the pharmacological solution S from the container 1.

The sealing element 3 is covered by the safety cap 4 which, in addition to contributing to the sealing of the container 1, also has a “tamper evident” function, highlighting any tampering with the container itself.

The safety cap 4 comprises two elements and is made entirely of plastic. Preferably, the safety cap 4 consists of only two elements.

The safety cap 4 comprises:
an inner cage 5, adapted to partially cover the sealing element 3 leaving at least one of its pierceable portions 31 exposed, and adapted to keep the sealing element 3 engaged inside the mouth 24 of the bottle 2 in the correct sealing position even when using the container 1,
an outer cap 6, adapted to completely cover the sealing element 3 and the inner cage 5 until the moment of use of the container 1, when said outer cap 6 may be removed by tearing to expose the pierceable portion 31 of the sealing element 3 intended to be pierced by the needle of a syringe to be able to withdraw the pharmacological solution S contained inside the bottle 2.

The inner cage 5 comprises a head 51, provided with a central opening 52 which allows access to the pierceable portion 31 of the sealing element 3, below which a cylindrical skirt 53 extends, ending in a lower edge 54 at which internally protruding retaining means 55 are provided. In fact, the inner cage 5 of the safety cap 4 snap-engages below the ridge 22 of the neck 21 of the bottle 2 by means of said retaining means 55.

The retaining means 55 are at least one hook-like ridge facing towards the inside of the inner cage 5, that is to say facing towards the inner surface of the skirt 531.

Preferably, the retaining means 55 are connected to the skirt 53 through the lower edge 54, which preferably has a curvilinear profile to further increase the flexibility of the retaining means 55.

The retaining means 55 are provided with a bearing space 551 defined between the retaining means itself and the inner surface of the skirt 531. As may be seen in FIGS. 5A and 5B, during the positioning of the inner cage 5 on the neck 21 of the bottle 2, the retaining means 55 compress, approaching the inner surface of the skirt 531 and occupying the bearing space 551, without deforming the inner cage 5.

Advantageously, the inner cage 5 of the safety cap 4 is provided with highly flexible retaining means 55, to facilitate the assembly steps of the container 1, and with a high clamping force, to best retain the inner cage 5 on the neck 21 of the bottle 2. By virtue of the retaining means 55 of the inner cage 5, once the snap coupling on the neck 21 of the bottle 2 has been obtained, no further fixing or retaining element will be required to keep the sealing element 3 firmly in the closed sealing position of the mouth 24 of the bottle 2 even if the outer cap 6 is completely removed by tearing.

The outer cap 6 is formed by a band 61, preferably cylindrical, closed at the top by a cover 62, preferably disc-shaped.

Preferably, the band 61 is elongated, i.e. it extends to cover the entire neck 21 of the bottle 2, as seen in FIG. 1. This solution considerably reduces the risks of tampering as it is more difficult to access underneath the safety cap 4 to try to tamper with it.

The cover 62 is connected to the band 61 by means of weakening 63 at an outer perimeter 623 of the spread cover. Such weakenings 63 are suitable for being torn apart to separate the cover 62 from the band 61, thus opening the outer cap 6 at the top to allow access to the sealing element 3. The weakenings 63 are a plurality of uniformly distributed thin bridges, as shown in FIG. 1, or necking lines of the material, or pre-cuts, or grooves.

Preferably, the band 61 also has weakenings 63 which facilitate the complete removal of the outer cap 6 of the safety cap 4 from the container.

The outer cap 6 is fixed to the bottle 2 by means of the interposition of the inner cage 5. The outer cap 6 of the safety cap 4 is in fact snap-engaged under the lower edge 54 of the inner cage 5 by means of coupling means 615.

The coupling means 615 are at least one relief protruding inside the band 61. Preferably, the coupling means 615 are in the form of a continuous annular relief, protruding from the inner surface of the band 611.

The sealing element 3 is a rubber cap having a cap head 33, preferably disc-shaped, below which the cap body 32, preferably cylindrical, extends.

The cap body 32 is intended to fit inside the neck 21 of the bottle 2, while the cap head 33 is intended to rest against the edge 23 to close the mouth 24 of the bottle itself.

The sealing element 3 is provided with a pierceable disc-shaped portion 31, arranged centrally to the cap head 33 and defined inside an annular edge 311.

With regard to the bottle 2 according to the present invention, unlike the known solutions shown in FIG. 1, the entire neck 21 has been redesigned to create the space necessary to house more than one fixing element of the rubber closure, that is, to house a closing device 10 as described above, without resizing the inner diameter of the neck.

The neck 21 of bottle 2 has an inner diameter Di of between 7 mm and 7.5 mm, preferably 7.3 mm.

The ridge 22 of the bottle 2 defines the maximum outer diameter of the neck 21, indicated by De. The maximum outer diameter De is between 11 mm and 12 mm, preferably 11.5 mm. As may be seen, the maximum outer diameter De of the bottle 2 according to the present invention has been considerably reduced with respect to that of a bottle of the prior art.

The thickness W of the bottle 2 at the neck 21 has also been considerably reduced with respect to that of a bottle of the prior art. The thickness W is between 1.2 mm and 1.4 mm, preferably 1.3 mm. The thickness W of the bottle 2 at the neck 21 is slightly greater than the thickness of the bottle in its lower part.

The height Hr of the ridge 22 has also been significantly reduced with respect to that of a bottle of the prior art. The height HR is preferably about 2 mm. HR of the ridge 22 is Preferably, the height approximately 4 of the total height of the neck indicated with Hc. Such solution allows having a large space at the neck 21 to house the closing device 10.

The maximum height L of the ridge 22 has also been significantly reduced with respect to that of a bottle of the prior art. The maximum width L is preferably less than 2.5 mm. Preferably, the maximum width L and the height Hr of the ridge 22 are substantially corresponding.

Preferably, the ridge 22 is provided with a specific profile specially designed to facilitate the assembly step of the closing device 10.

Preferably, the ridge 22 is provided with an upper bevel 221 having an inclination angle α between 25° and 35°, preferably of 30°.

Preferably, the ridge 22 is provided with a lower recess 222 having a rounded profile, which forms an annular seat which better accommodates the retaining means 55 of the closing device 10. Preferably, the rounded profile of the lower recess 222 has a radius of 0.5 mm.

The present invention also relates to a container 1 for parenterally administrable pharmaceutical products comprising a bottle 2 closed by a closing device 10 as described above, i.e. made of a sealing element 3, for example made of rubber, and a safety cap 4, for example made of plastic, partially tear-off and adapted to guarantee the authenticity of the container, highlighting any tampering.

Advantageously, a container 1 thus made is provided with a particularly effective anti-tampering system, while maintaining reduced overall dimensions. As may be seen in FIG. 1, in fact, the closing device 10 according to the present invention has an outer diameter which is smaller than or at most corresponding to the outer diameter of the bottle 2. Even more advantageously, in the case of a closing device 10 with an outer diameter corresponding to the outer diameter of the bottle 2, the container 1 has an overall cylindrical e which considerably facilitates the handling thereof, especially in the case of simultaneous filling of several containers in completely automated systems.

Preferably, the bottle 2 is made of glass.

As far as the materials are concerned, the technical solutions described above are applied to plastic closing devices 10, to glass bottles 2, to sealing elements 3 in thermosetting rubber or thermoplastic rubber.

Innovatively, a bottle for a container for parenterally administrable drugs according to the present invention allows all the intended objects as described above to be achieved in a particularly effective manner.

Advantageously, a bottle for a container for parenterally administrable pharmaceutical products according to the present invention is provided with a completely redesigned neck and relative ridge to offer greater space for the closing device, while ensuring a sufficient fixing grip against any tampering, and while maintaining reduced dimensions without resizing the inner diameter Di.

It is clear that those skilled in the art may make changes to the bottle and to the container described above, all falling within the scope of protection as defined in the following claims.

What is claimed is:

1. A bottle for a container for parenterally administrable pharmaceutical products, the bottle comprising a neck having a neck height, and ending superiorly in an access mouth defined by a radially protruding ridge having a ridge height and a maximum width;
wherein the ridge height is about ¼ of the neck height and the maximum width of the ridge substantially corresponds to the ridge height.

2. The bottle of claim 1, wherein the neck has an inner diameter between 7 mm and 7.5 mm.

3. The bottle of claim 1, wherein the neck has a maximum outer diameter defined by the ridge, and said maximum outer diameter is between 11 mm and 12 mm.

4. The bottle of claim 1, wherein the maximum width from the ridge is less than 2.5 mm.

5. The bottle of claim 1, wherein the ridge is provided with an upper bevel having an inclination angle α between 25° and 35°.

6. The bottle of claim 1, wherein the ridge is provided with a lower recess having a rounded profile having a radius of 0.5 mm.

7. The bottle of claim 1, wherein the bottle is made of glass.

8. A container for parenterally administrable pharmaceutical products, the container comprising:
a bottle comprising a neck having a neck height, and ending superiorly in an access mouth defined by a radially protruding ridge having a ridge height and a maximum width, wherein the ridge height is about ¼ of the neck height and the maximum width of the ridge substantially corresponds to the ridge height; and
a plastic closing device comprising:
an inner cage provided with a central opening and ending in a lower edge at which at least one hook-like ridge is provided for permanent snap engagement of the neck of the bottle below the ridge;
an outer cap snap-engaged below the lower edge of the inner cage through at least one internally protruding relief, and provided with tearable weakenings to allow removal of the outer cap by tearing; and
a rubber sealing element housed inside the inner cage so that, once the outer cap has been removed, a pierceable portion of said rubber sealing element is accessible from outside through the central opening of the inner cage.

9. The container of claim 8, wherein an outer diameter of the closing device is smaller than, or at most corresponds to, an outer diameter of the bottle.

10. The container of claim 8, wherein the bottle and the closing device define a cylindrical shape as a whole.

11. The bottle of claim 1, wherein the ridge is provided with an upper bevel having an inclination angle α of 30°.
